(19) United States
(12) Patent Application Publication
(10) Pub. No.: US 2025/0067388 A1
(43) Pub. Date: Feb. 27, 2025

(54) SEISMIC BRACING YIELD FUSE

(71) Applicant: MASEK, MCMULLIN AND LARSEN, LLC, Roy, UT (US)

(72) Inventors: John P. MASEK, Roy, UT (US); Paul W. McMULLIN, Sandy, UT (US); Blake C. LARSEN, Hooper, UT (US)

(73) Assignee: MASEK, MCMULLIN AND LARSEN, LLC, Roy, UT (US)

(21) Appl. No.: 18/639,497

(22) Filed: Apr. 18, 2024

Related U.S. Application Data
(60) Provisional application No. 63/578,333, filed on Aug. 23, 2023.

(51) Int. Cl. F16M 13/02

(52) U.S. Cl. CPC F16M 13/02

(57) ABSTRACT

Embodiments of the disclosure include a seismic bracing yield fuse for seismically bracing nonstructural equipment from a structural member of a building. The seismic bracing yield fuse includes a fuse member configured to undergo ductile yielding in a length dimension upon application of a tensile or compressive force along the length dimension of the fuse member. The fuse member includes two ends and a central bar positioned between the two ends. The central bar includes a neck down portion including a substantially constant cross section.

### CROSS REFERENCE TO RELATED APPLICATIONS

This application claims priority to and the benefit of U.S. Provisional Patent Application No. 63/578,333, filed Aug. 23, 2023, and entitled SEISMIC BRACING YIELD FUSE, the disclosures of which is incorporated herein by reference in its entirety.

### TECHNICAL FIELD

The present disclosure relates generally to seismic bracing of nonstructural overhead utility systems or equipment to a structural member of a building or other facility. In particular, the present disclosure relates to seismic bracing for use applications, and yield fuses for use in seismic bracing.

### BACKGROUND

Until the adoption of the 2012 International Building Code (IBC), which refers to the American Society of Civil Engineers (ASCE) document 7-10, the standard methodology for designing seismic braces of nonstructural items was to restrain these systems with either rigid braces or cable braces that were designed to have sufficient strength to resist seismic forces calculated based on ASCE 7-10 requirements. “Nonstructural” refers to systems other than the building structural systems (such as walls, beams, columns, building braces) themselves. Nonstructural items include piping systems, mechanical ductwork, electrical conduit and cable trays, mechanical or electrical systems, ceiling systems, and interior walls that are attached to the structure, but not part of the structure itself. It is anticipated that an Omega value concept will remain in the building code, as the structural engineering profession regards ductile yielding to be an important component of good seismic performance of structural components of buildings and more recently also nonstructural components within buildings.

Beginning with the 2012 IBC and ASCE 7-10, a factor referred to as “Omega” was implemented regarding the relative strength of anchors to concrete or masonry in comparison to nonstructural brace strength. This Omega factor was subsequentially also included in the current 2018 IBC, which references ASCE 7-16. This requirement currently states that the force used in seismic anchor design to concrete or masonry must be increased by a factor of 2.0, unless it can be demonstrated that the connection to the structure provides ductile yielding. Since prior to the 2012 IBC requirements commercially available brace connections had been designed to be strong and rigid with respect to nonstructural brace and anchor strength, commercially available bracing products under the 2012 IBC requirements now require multiplying the anchor force by 2.0 or 200%. The next version of the building code (the 2024 IBC, which will reference ASCE 7-22) again requires the use of an Omega factor. Omega will also be 2.0 for most nonstructural items. Building structures themselves have had similar requirements added in preceding codes beginning in the late 1990s, resulting in the development of energy absorbing ductile connection devices for large systems in building braces and beam to column assembles. These assemblies are not usable for nonstructural items due to their large size and use of heavy steel assemblies or concrete-filled tube assemblies.

For the foregoing reasons, there is a need to provide improved supports and bracing for nonstructural items that are lightweight, compact and usable with existing commercial products.

### SUMMARY

The present disclosure is directed to supports and bracing for use with nonstructural items in a building. Such supports typically provide connection of a nonstructural item to a structural member (e.g., a structural floor slab, beam, column, or wall) of a building. The present disclosure relates particularly to seismic bracing for nonstructural items, and yield fuses for use with seismic bracing.

The seismic bracing generally, and the yield fuse specifically, typically includes a lightweight, compact assembly that weighs ounces (at most less than 1-2 pounds) rather than much larger bracing (which can weight several hundred to thousands pounds for each brace) that is typical for bracing used with structural features of a building. The yield fuses disclosed herein typically can be used in conjunction with the many already available commercial nonstructural bracing products. In one embodiment, the connection devices typically weigh between a few ounces to a pound, although larger versions are possible. The yield fuses may have several configurations to adapt to many different existing commercially available bracing systems. Most importantly, the yield fuses permit the use of Omega=1.0 instead of Omega=2.0, as is required by the 2012, 2015, 2018 and 2022 IBC requirements described above. Thus, nonstructural seismic bracing can be accommodated with significantly fewer braces and brace anchors. This is achieved by the use of a ductile-yielding nonstructural brace fuse in the seismic bracing (as current codes encourage). The fuse may have any of a variety of configurations that permit some yielding under certain load conditions (e.g., a seismic event). One configuration includes a yielding “dumbbell” shaped fuse member. Another configuration includes a yielding “dumbbell curve shaped fuse member. Yet another configuration includes a yielding “straight” shaped fuse member. Yet another configuration includes a yielding “dog-bone” shaped fuse member. These and other configurations of the present disclosure may reduce the required anchor forces by 200% and may also provide superior brace performance by yielding of the brace fuse, rather than sudden brittle failure of the brace anchor bolts.

Another aspect of the present disclosure relates to a seismic bracing yield fuse that it may include at least one housing member and a fuse member. The fuse member may be housed within or mounted externally to the at least one housing member. The fuse member is configured to undergo ductile yielding in a length dimension upon application of a tensile or compressive force along the length dimension of the fuse member. The at least one housing member is configured to accommodate a change in length of the fuse member resulting from the ductile yielding.

The fuse member may have a dumbbell or similar shape. Specifically, the fuse member may include two lobes connected to each other by a central bar. The two lobes may have any shape that enables the fuse member to operate as described herein. In the illustrated embodiments, the two lobes each have a rectangular or square shape. In alternative embodiments, the two lobes may each have an oval or circular shape. Additionally, the central bar may include a substantially straight connection between the two lobes and the central bar may have a reduced width along a length of the central bar between the two lobes. The central bar or plate defines a neck down portion that has a substantially constant cross section along the length of the central bar. Without being bound by theory, the neck down portion of the dumbbell shaped fuse has a longer substantially constant cross section length than neck down portions of other fuses. Surprisingly, in laboratory testing done by the applicant, the longer substantially constant cross section length enables the dumbbell shaped fuse to absorb greater amounts of energy than other fuse designs despite the fact that other fuse designs have larger amounts of material in the neck down portion. Surprising, laboratory testing performed by the applicant revealed the substantially constant cross section has the ability to yield to a greater extent than other fuse geometry.

The at least one housing member may have a single-piece construction and apertures formed therethrough at opposing ends of the housing member. At least one of the apertures may have a slot shape, and the fuse member may have apertures formed therethrough at opposing ends that are aligned with the housing apertures and receptive of connection features. The slot-shaped aperture may accommodate the change in length of the fuse member resulting from the ductile yielding.

The fuse may also include an overload plate configured to aid and back up the fuse member. The overload plate backs up the yielding fuse such that when the fuse fails or deforms excessively, the system can continue to carry a load. In the illustrated embodiment, the overload plate used in laboratory testing was approximately three times stronger than the fuse. Test data further indicated that the system yields such that the deformation curve of the system is a two-stage yield-deformation curve. The first portion of the two-stage yield-deformation curve corresponds to the fuse member yielding, and then undergoing ductile elongation. The second portion of the two-stage yield-deformation curve corresponds to the overload plate yielding and then undergoing ductile elongation. The two-stage yield-deformation behavior will adsorb seismic energy at a low force, initially, and moderate force afterwards such that the overload plate increases redundancy and reliability.

In another embodiment, the fuse member may have a straight shape. The fuse member may have a substantially constant width along a length of the fuse member. In yet another embodiment, the fuse member may have a rod shape. The fuse member may have substantially flat lobes for connection to bolts or other fasteners and may include a substantially cylindrical central bar connecting the two substantially flat lobes.

The fuse member may have a dog bone shape. The fuse member may have a reduced width at a location spaced between opposing ends of the fuse member. The fuse member may include a corrugated structure. The fuse member may include a rod-shaped member that is mounted to an exterior surface of the at least one housing member.

One housing member configuration may include a first housing member at least partially inserted into a second housing member. In the illustrated embodiment, the first housing member and the second housing member each have a length that substantially corresponds to a length of the fuse member. The first housing member is positioned on a first side of the fuse member and the second housing member is positioned on a second side of the fuse member. The first housing member and/or the second housing member may be configured to attached positively to the first housing member and/or the second housing member such that the first housing member and the second housing member enclose and protect the fuse member. This may include a snap-in-place or other quick assembly method. The ability to snap the first housing member and the second housing member together over the fuse member enables quicker installation of the fuse member. The fuse member is positionable within the housing assembly or mounted to the housing. The fuse member has an elongate construction and is deformable in a length dimension upon application of a force such that the fuse member may undergo ductile deformation.

The housing assembly may include housing connector apertures formed in opposing ends thereof, wherein the housing connector apertures are receptive of connection members to connect the seismic bracing yield fuse to a non-structural item. The non-structural item may include at least one of piping systems, mechanical ductwork, electrical conduit and cable trays, and mechanical or electrical systems, or other nonstructural items, such as suspended ceilings or nonstructural walls. The fuse member may include fuse connector apertures formed in opposing ends thereof, wherein the housing apertures are aligned with the fuse connector apertures and receptive of the connection members. The first and second housing members may each include mounting tabs positioned on exterior surfaces thereof, wherein the mounting tabs are configured to mount the fuse member to the housing assembly. The seismic bracing yield fuse may include first and second fuse members arranged in parallel and mounted to exterior surfaces of the fuse assembly.

The seismic bracing yield fuse may also include a backup wire extending between and securing together the first and second housing members as an assembly. The seismic bracing yield fuse may include a connector bracket mounted to the fuse member and the at least one housing member. The fuse member may include a material having a different ductility than material of the at least one housing. The fuse member may have a higher ductility than a connecting member to which the seismic bracing yield fuse is connected. The at least one housing member may include an integrally formed angled portion extending from an end thereof. The at least one housing member may have a rectangular cross-sectional shape.

A further aspect of the present disclosure relates to a method of assembling a seismic bracing yield fuse. The method includes providing a housing assembly and a fuse member, the fuse member being configured to undergo ductile yielding in a length dimension upon application of a tensile or compressive force along the length dimension of the fuse member, mounting the fuse member internal the housing assembly or to an exterior of the housing assembly, and providing connection features to secure opposing ends of the fuse member to a connection assembly for application of the tensile or compressive force.

Another aspect of the present disclosure relates to a method of providing a ductile yield in a connection assembly that supports nonstructural equipment from a structural member of a building. The method includes providing a seismic bracing yield fuse having a housing and a fuse member, connecting the seismic bracing yield fuse in series between the structural member and the nonstructural equipment, and applying a tensile or compressive force to the fuse member until the fuse member undergoes ductile yielding.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other nonstructural bracing for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a top view of a fuse member in accordance with the present disclosure.

FIG. 2 is a top view of an overload plate in accordance with the present disclosure.

FIG. 3A illustrates a perspective view of a fuse assembly with a separable housing assembly shown as transparent to also illustrated a fuse member positioned within the housing assembly in accordance with the present disclosure.

FIG. 3B illustrates a perspective view of a fuse assembly with a unitary housing assembly shown as transparent to also illustrated a fuse member positioned within the housing assembly in accordance with the present disclosure.

FIG. 4 illustrates a side view of the fuse assembly shown in FIG. 3 in accordance with the present disclosure.

FIG. 5 illustrates a top view of the fuse assembly shown in FIGS. 3 and 4 with the housing assembly shown as transparent to also illustrated the fuse member positioned within the housing assembly in accordance with the present disclosure.

FIG. 6 illustrates an end view of the fuse assembly shown in FIGS. 3-5 in accordance with the present disclosure.

FIG. 7 illustrates the results of a test conducted on the fuse member with a one-sided backup plate, as shown in FIGS. 1 and 2 in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is directed to bracing and/or connecting devices for use in supporting nonstructural items from a structural member in a building. Such structural members, when formed from concrete, may include concrete flat slabs, concrete waffle slabs, concrete panel slabs, concrete over metal deck, concrete beams, or concrete columns within a building or facility. Such structural elements, when formed from masonry are typically interior or exterior walls of buildings. The fuse device may also be used when attaching nonstructural seismic bracing to other structural members, such as steel beams, steel columns, steel trusses, or any other structural member that comprises the building or structure itself. The fuse may be characterized as a seismic bracing yield fuse at least in part because the bracing is used as a bracing member to support the nonstructural item from a structural member of a building in the event of a seismic event. The yield fuse may refer to the fuse being configured to yield when a load above a threshold amount is applied to the seismic bracing and/or fuse, such as during a seismic event. The use of a yielding fuse may permit use of an Omega factor of 1.0 rather than the otherwise required Omega factor of 2.0 under the current 2018 IBC requirements discussed above.

The embodiments for a seismic bracing yield fuse disclosed herein with reference to the figures are exemplary only. The general principles applicable to these yield fuses may be used in other related embodiments and designs to help avoid the need to use an Omega factor of 2.0 under the current 2018 IBC requirements as well as future IBC requirements. As discussed above, using an Omega factor of 1.0 greatly enhances a designer's ability to create a seismic bracing design that is cost-effective and meets practical size and weight limitations associated with supporting nonstructural items in a building.

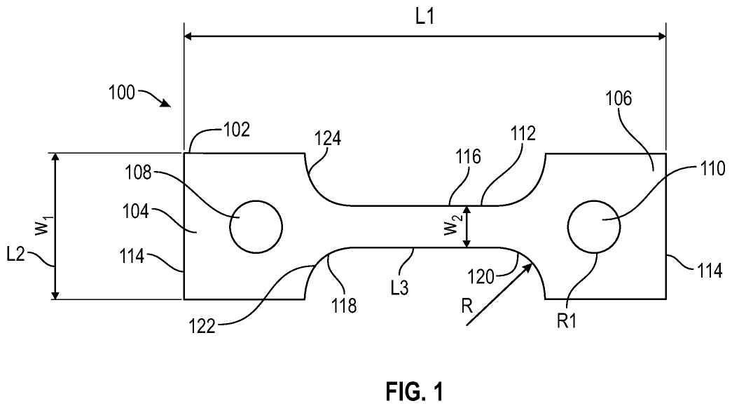

Referring now to the figures, examples of seismic bracing yield fuse assemblies are illustrated in FIGS. 1-6. The fuse assemblies may include a fuse member, a housing assembly, and/or an overload plate or plates. In some embodiments, the fuse assembly only includes the fuse member and does not include any other elements. In some embodiments, the fuse assembly includes a fuse member positioned in a housing assembly and does not include an overload plate. In some embodiments, the fuse assembly includes a fuse member and an overload plate, or plates, and does not include a housing assembly. In some embodiments, the fuse assembly includes a fuse member, a housing assembly, and an overload plate. The housing member itself may also function as an overload plate assembly.

Refer now to FIG. 1, an example of seismic bracing yield fuse assembly 100 including only a fuse member 102 is shown and described. The seismic bracing yield fuse assembly 100 includes the fuse member 102, a first connector member (e.g., bracing cable, not shown), a second connector member (e.g., bracket, not shown), and a fastener (not shown) used to secure the second connector member to the fuse member 102. The fastener may be a bolt, screw, rivet or other fastener. The second connector may include an aperture (not shown) to receive the fastener.

The fuse member 102 includes first and second lobes or ends 104, 106, first and second fuse apertures 108, 110, and a neck down portion 112. The fuse member 102 has a width W₁ in the area adjacent to the first and second fuse apertures 108, 110, a length L₁ between the first and second lobes or ends 104, 106, a thickness Ti, and a reduced width W₂ in the area of the neck down portion 112 at a location spaced between the first and second lobes or ends 104, 106. The fuse member 102 may be referred to as having a dumbbell shape. The limited amount of material in the neck down portion 112 as compared to other locations along the length of the fuse member 102 may result in the fuse member 102 yielding first in neck down portion 112 upon application of a tensile or compressive load or force along the length of the fuse member 102. The tensile or compressive load may be applied via the first and second apertures 108, 110. The first and second connector members may be mounted to the fuse member 102 via the first and second fuse apertures 108, 110. The yielding of the fuse member 102 may result in an elongation of the fuse member 102, thereby increasing the length L₁. The amount of tensile or compressive force applied to the fuse member 102 typically is sufficient to elongate the fuse member 102 substantially but not to the point of failure. In the illustrated embodiment, the width W₁ is about 0.75 inches to about 2.5 inches depending on the load rating of the fuse member 102.

As shown in FIG. 1, the first and second lobes or ends 104, 106 are substantially rectangular or square shaped. In alternative embodiments, the first and second lobes or ends 104, 106 may be any shape that enables the fuse member 102 to operate as describe herein. In the illustrated embodiment, the first and second lobes or ends 104, 106 each have the same shape. In alternative embodiments, the first and second lobes or ends 104, 106 may each have different shapes including, but not limited to, circular or oval shapes.

In the illustrated embodiment, the first and second lobes or ends 104, 106 each have three substantially straight sides 114 of substantially equal length L₂. In alternative embodiments, the sides 114 may each have different lengths or widths. In the illustrated embodiment, the width W₁ is about 0.75 inches to about 2.5 inches depending on the load rating of the fuse member 102.

In the illustrated embodiment, the first and second fuse apertures 108, 110 are substantially circular or oval shaped. In alternative embodiments, the first and second fuse apertures 108, 110 may be any shape that enables the fuse member 102 to operate as describe herein. In the illustrated embodiment, the first and second fuse apertures 108, 110 each have the same shape. In alternative embodiments, the first and second fuse apertures 108, 110 may each have different shapes including, but not limited to, rectangular or square shaped.

In the illustrated embodiment, the first and second fuse apertures 108, 110 each have substantially equal radii R₁. In alternative embodiments, the first and second fuse apertures 108, 110 may each have different radii R₁. In the illustrated embodiment, the radii R₁ are about ¼″ inches to about 1.0 inches depending on the load rating of the fuse member 102. Alternate radii may also be included in other embodiments.

The fuse member 102 includes a central bar 116 includes the neck down portion 112 and two transition portions 118, 120 that connect the first and second lobes or ends 104, 106 to the neck down portion 112. As shown in FIG. 1, the neck down portion 112 includes a substantially straight connection between the first and second lobes or ends 104, 106 that has the reduced width W₂ along a length L₃ of the neck down portion 112. Without being bound by theory, the neck down portion 112 has a longer substantially constant cross section length L₃ than neck down portions of other fuses. Laboratory testing by the applicants revealed that, this longer substantially constant cross section length L₃ enables the dumbbell shaped fuse to absorb greater amounts of energy than other fuse designs. Surprising, the substantially constant cross section has the ability to yield to a greater extent than other fuse geometry including fuse geometries including neck down portions including radial cut geometries. In the illustrated embodiment, the length L₃ is about 1.5 inches to about 5 inches depending on the load rating of the fuse. For example, In the illustrated embodiment for a W1 of 1″, the width W₂ is about 30% (approximately 0.30 inches) to about 60% (approximately 0.60 inches) of the width W₁ depending on the load rating of the fuse member 102.

The two transition portions 118, 120 are substantially curved to provide a stronger transition between the first and second lobes or ends 104, 106 and the neck down portion 112. Each transition portion 118, 120 includes two curved transitions 122, 124 positioned on either side of the neck down portion 112. In the illustrated embodiment, the curved transitions 122, 124 each have substantially equal radii R₂. In alternative embodiments, the curved transitions 122, 124 may each have different radii R₂. In the illustrated embodiment, the radii R₂ are about ¼ inches to about 1 inch depending on the load rating of the fuse member 102.

Additionally, the fuse member 102 may be formed of any material that enables the fuse assembly to operate as describe herein. For example, the fuse member 102 may be formed of steel, aluminum, iron, copper, and/or any other ductile material. Moreover, the fuse member 102 may have any thickness that enables the fuse assembly to operate as describe herein. For example, the fuse member 102 may have a thickness of about 24 gage to about 3/16″, depending on the load rating of the fuse. Furthermore, the fuse member 102 may have any length L₁ that enables the fuse assembly to operate as describe herein. For example, the fuse member 102 may have a length L₁ of about 3 inches to about 8 inches.

As discussed above and without being bound by theory, the neck down portion 112 has a longer substantially constant cross section length L₃ than neck down portions of other fuses. The neck down portions of other fuse elements may be longer but these neck down portions are curved and not straight. That is, the cross section of the neck down portions are not substantially constant along the length of the neck down portion. Testing performed by the applicants revealed this longer substantially constant cross section length L₃ enables the fuse member 102 to absorb greater amounts of energy than other fuse designs despite the fact that other fuse designs may have larger amounts of material in the neck down portion. Also surprising, the substantially constant cross section has the ability to yield to a greater extent than other fuse geometry including fuse geometries including neck down portions including radial cut geometries. According, the substantially constant cross section of the neck down portion 112 enables the fuse member 102 to absorb more energy than existing fuse members.

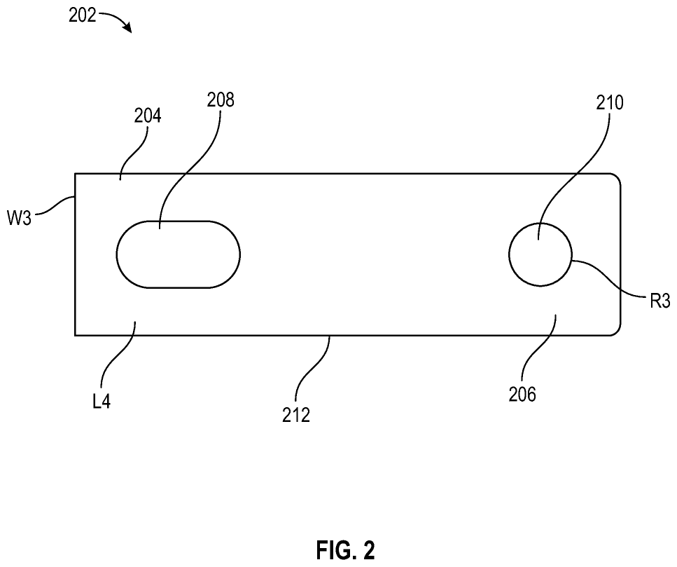

FIG. 2 illustrates an example of an overload plate 202. The overload plate 202 may be used in combination with a fuse member such as fuse member 102 to increase the overall strength of the fuse assembly (not shown). Specifically, the overload plate 202 may be held in place using the same fasteners that hold the fuse member 102 such that the overload plate 202 and the fuse member 102 are stacked on top of each other in the fuse assembly (not shown).

The overload plate 202 includes first and second ends 204, 206, first and second overload plate apertures 208, 210, and a middle portion 212. The overload plate 202 has a width W₃ along a length L₄ between the first and second ends 204, 206. The overload plate 202 may be referred to as having a straight shape without a reduced amount of material in the middle portion 212 or a neck down portion. The straight shape of the overload plate 202 as compared to the fuse member 102 may result in the overload plate 202 yielding later than the fuse member 102 upon application of a tensile or compressive load or force along the length of the overload plate 202. The tensile or compressive load may be applied via the first and second overload plate apertures 208, 210 and typically only after the fuse member 102 has deformed sufficiently for bolts in apertures 208 and 210 to engage to overload plate. The first and second connector members may be mounted to the overload plate 202 via the first and second fuse overload plate apertures 208, 210. The yielding of the overload plate 202 may result in an elongation of the overload plate 202, thereby increasing the length L₄. Alternately, the apertures 204 and 210 may elongate, with no substantial elongation of the overload plate itself. The amount of tensile or compressive force applied to the overload plate 202 typically is insufficient to elongate the overload plate 202 to the point of failure (i.e., the overload plate 202 breaking into two pieces). In the illustrated embodiment, the overload plate 202 may have a length L₄ of about 3 inches to about 8 inches. In the illustrated embodiment, the width W₃ is about 0.75 inches to about 2.5 inches depending on the load rating of the fuse member 102.

As shown in FIG. 2, the overload plate 202 has a substantially straight shape such that the first and second ends 204, 206 are substantially rectangular or square shaped and the middle portion 212 is also substantially rectangular or square shaped. In alternative embodiments, the overload plate 202, the first and second ends 204, 206 and/or the middle portion 212 may be any shape that enables the overload plate 202 to operate as describe herein.

In the illustrated embodiment, the first and second overload plate apertures 208, 210 are substantially circular or oval shaped. In alternative embodiments, the first and second overload plate apertures 208, 210 may be any shape that enables the overload plate 202 to operate as describe herein. In the illustrated embodiment, the first overload plate aperture 208 has a circular shape and the second overload plate aperture 210 has an oval shape. In alternative embodiments, the first and second overload plate apertures 208, 210.

In the illustrated embodiment, the first and second overload plate apertures 208, 210 each have substantially equal radii R₃. In alternative embodiments, the first and second overload plate apertures 208, 210 may each have different radii R₃. In the illustrated embodiment, the radii R₃ are about ⅜ inches to about ⅝ inches depending on the load rating of the overload plate 202.

The fuse assembly may also include the overload plate 202 that is configured to aid and back up the fuse member 102. The overload plate 202 backs up the fuse member 102 such that when the fuse member 102 fails, or elongates to a predefined limit, the fuse assembly as a whole can continue to carry a load. In testing performed by the applicants, in the illustrated embodiment, the overload plate 202 was approximately three times stronger than the fuse member 102 and test data indicates that the fuse assembly yields such that the deformation curve of the fuse assembly is a four-stage yield-deformation curve. Referring to FIG. 8, the first portion of the four-stage yield-deformation curve corresponds to the fuse member yielding, deforming linearly in proportion to increasing load. In the second stage, the fuse deforms substantially in a plastic mode. The third portion of the four-stage yield-deformation curve corresponds to the overload plate yielding and deforming elastically. The fourth stage of the yield-deformation curve corresponds to plastic deformation of the overload plate. This four-stage yield-deformation behavior will adsorb seismic energy at a low force, initially, and moderate to high forces afterwards, such that the overload plate 202 increases redundancy and reliability of the overall assembly. This is a highly desirable behavior for earthquake load resistance.

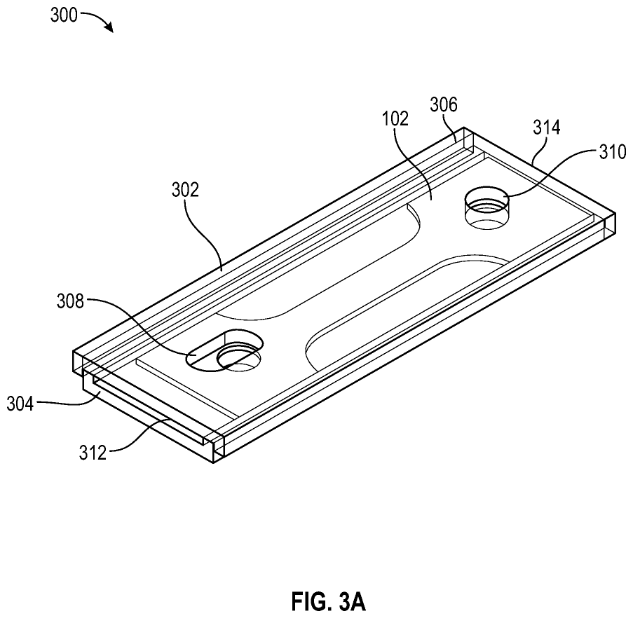

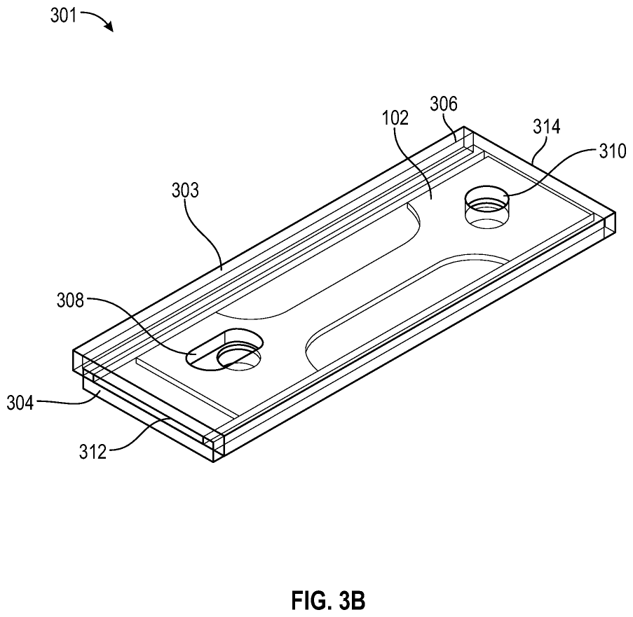

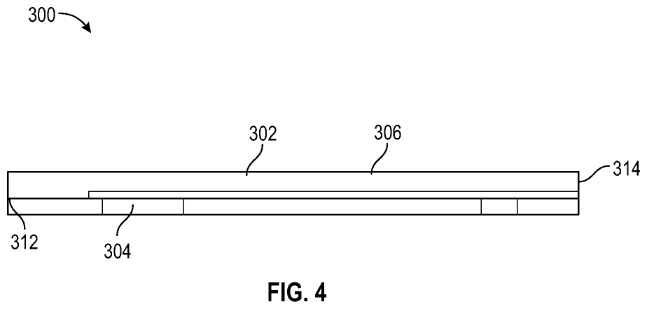

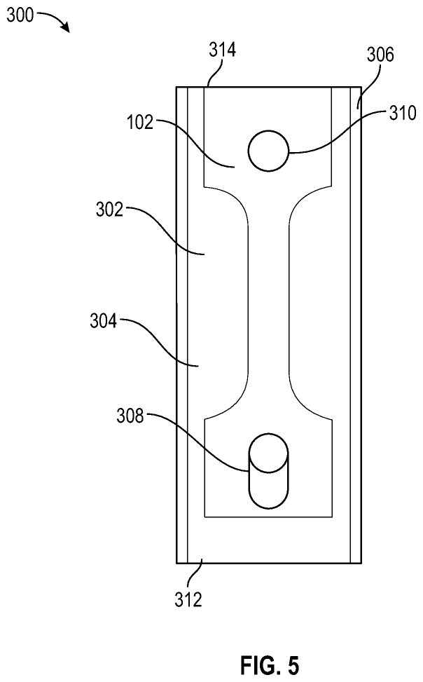

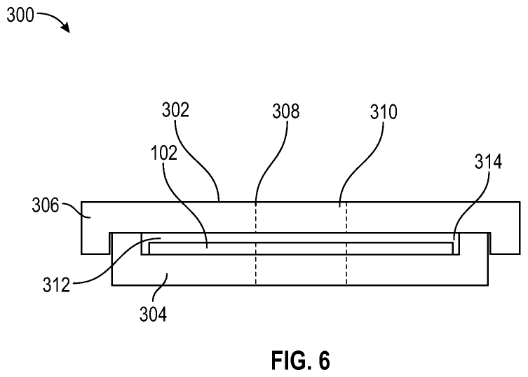

FIGS. 3-6 illustrate an example fuse assembly 300 including the fuse member 102 and a housing assembly 302. Specifically, FIG. 3 illustrates a perspective view of the fuse assembly 300 with the housing assembly 302 shown as transparent to also illustrated the fuse member 102 positioned within the housing assembly 302. FIG. 4 illustrates a side view of the fuse assembly 300. FIG. 5 illustrates a top view of the fuse assembly 300 with the housing assembly 302 shown as transparent to also illustrated the fuse member 102 positioned within the housing assembly 302. FIG. 6 illustrates an end view of the fuse assembly 300.

FIG. 3A illustrates a separable housing assembly 302. The housing assembly 302 includes first and second housing members 304, 306 that have respective first and second housing apertures 308, 310. The housing members 304, 306 each include open ends 312, 314. In an alternative embodiment, either of ends 312, 314 could be closed ends, but not both. The first housing member 304 defines an internal cavity sized to receive the second housing member 306 in a snapping or other engagement as shown in FIGS. 3-6. The internal cavities of both the first and second housing members 304, 306 are sized to receive portions of the fuse member 102. The snapping or other engagement mechanism between the first and second housing members 304, 306 enables the housing assembly 302 to receive the fuse member 102. In the illustrated embodiment, the housing assembly 302 only receives the fuse member 102. In this case, the housing may function as the overload plate(s). In alternative embodiments, the housing assembly 302 receives the fuse member 102 and a separate overload plate 202.

FIG. 3B illustrates an alternative embodiment of the separable housing assembly 302. Specifically, FIG. 3B illustrates a unitary housing assembly 301 including a single housing member 303 that has first and second housing apertures 308, 310. The housing member 303 includes open ends 312, 314. In an alternative embodiment, either of ends 312, 314 could be closed ends, but not both. The housing member 303 defines an internal cavity sized to receive portions of the fuse member 102 by sliding the fuse member 102 into the internal cavity through the open ends 312, 314. In the illustrated embodiment, the housing assembly 303 only receives the fuse member 102. In this case, the housing may function as the overload plate(s). In alternative embodiments, the housing assembly 302 receives the fuse member 102 and a separate overload plate 202.

When assembled, the seismic bracing yield fuse 300 provides for the first fuse aperture 108 to be aligned with the first housing aperture 308, the second fuse aperture 110 to be aligned with the second housing aperture 310, the first connector member (not shown) to extend through the second apertures 110, 310, and the fastener (not shown) to extend through the first apertures 108, 308 to secure the second connector member (not shown) to the housing assembly 302. The second connector member (not shown) extends beyond the end of the first housing member 304. The second connector member (not shown) may have a bent or angled shape and an aperture (not shown) to promote connection of the seismic bracing yield fuse 300 to a nonstructural item or to nonstructural ceiling mount or connector. In some embodiments, the fasteners and/or the first and/or second connector members may be connected to a wire that is also connected to a nonstructural item or a structural item. In some embodiments, the fasteners and/or the first and/or second connector members may be connected to a solid structural compression member (such as a compression strut, angle, or other structural shape). That is, the fuse assembly may be connected to wires or solid structural compression members (such as a compression strut, angle, or other structural shape). For example, the second connector member (not shown) may be secured to a seismic ceiling mount (not shown) or to a structural element, such as a beam or wall (not shown) of a building. The first connector member (not shown) may be connected to a nonstructural item (not shown) via a nonstructural ceiling connector (not shown). The nonstructural item (not shown) may be secured to the floor slab (not shown) with a nonstructural floor slab mount (not shown). Typically, the nonstructural item (not shown) is secured to the floor slab (not shown) with nonstructural attachment fittings (not shown) and seismic bracing yield fuses (not shown) that are part of a seismic bracing assembly (not shown).

In the illustrated embodiment, the fasteners are tightened to a predetermined torque to enable the fuse member 102 to move within the housing assemblies 301 and 302. Specifically, if the fasteners are tightened too tight, the housing assemblies 301 and 302 press down on the fuse member 102 and the housing assemblies 301 and 302 and the fuse member 102 essentially act as a single unit. As such, the fasteners are tightened to a predetermined torque to enable the fuse member 102 to move within the housing assemblies 301 and 302. In the illustrated embodiment, the fasteners include brake-off nuts that prevent the nut from being tightened above a certain torque such that the fuse member 102 is capable of moving within the housing assemblies 301 and 302. In an alternative embodiment, the fuse assemblies 300 and 301 may include a polytetrafluoroethylene sheet positioned between the fuse member 102 and the housing assemblies 301 and 302 that enables the fuse member 102 to move within the housing assemblies 301 and 302.

In another example a seismic bracing yield fuse (not shown) may include an additional backup wire (not shown). The backup wire (not shown) includes first and second wire connectors (not shown) positioned at opposing ends. The first wire connector (not shown) is configured to align with the fuse aperture (not shown), housing aperture (not shown), and aperture (not shown) of the second connector (not shown) through which the fastener (not shown) is inserted to provide an assembly of those parts. The second wire connector (not shown) is configured to align with the second fuse aperture (not shown) and the second housing aperture (not shown) and be receptive of the first connector member (not shown) to provide assembly of those parts. The backup wire (not shown) may function as a safety measure to ensure that the assembly of parts of the seismic bracing yield fuse, in particular the assembly of the housing members (not shown) remains intact in the event that there is failure of the fuse member (not shown).

The backup wire (not shown) may comprise a wire having the same or greater strength than, for example, the first connector member (not shown). The backup wire (not shown) may be flexible along its length to permit relative movement between the first and second housing members (not shown), such as during yielding of the fuse member (not shown). The backup wire (not shown) may have a length (not shown) between the apertures of the first and second wire connectors (not shown). The length may be greater than length L₁ and length L₂ and may be greater than any length L₁ that is possible up to the point of failure of the fuse member (not shown). In some embodiments, the length is sufficiently short to prevent yielding of the fuse member (not shown) to a point of failure, such as a length that is equal to or less than the length L₁ achieved prior to the point of failure of the fuse member (not shown).

The first and second wire connectors (not shown) may be formed integral as a single piece with a wire portion (not shown) of the backup wire (not shown). In other embodiments, the first and second wire connectors (not shown) may be formed as separate connector members that are secured to the wire portion (not shown) in a later assembly step, such as by welding or the like.

The backup wire (not shown) may be used with any of the embodiments disclosed herein to provide an improved safety constraint that prevents disassembly of the seismic bracing yield fuse in the event of the fuse member failing. In the applications, the backup wire (not shown) may prevent disconnection of the seismic ceiling mount (not shown) from the first connector member (not shown).

The embodiments disclosed with reference to FIGS. 3-6 provide a housing assembly that is intended to function as a protecting the fuse member. The housing members shown with reference to FIGS. 3-6 may be configured in a way such that they do not transfer the tensile or compressive forces to the fuse member, but instead are intended specifically not to transfer tensile or compressive forces to the fuse members. Alternately, the housing members may function as the backup plate(s) themselves without a separate enclosed backup plate. The fuse members described with reference to FIGS. 1-6 may in some embodiments be used as a seismic bracing yield fuse independent of the housing assembly. That is, the housing assembly shown in the embodiments of FIGS. 3-6 may be removed without influencing the ability of the seismic bracing yield fuse to provide its intended function of providing a yield fuse in a seismic bracing application for a non-structural item of a building. The housing assemblies described with reference to FIGS. 3-6 may also be referred to as a backup plate(s), or an enclosure for the fuse member, or the like to provide a secondary backup load resisting system and to protect the fuse member from environmental conditions such as, for example, during assembly of the seismic bracing yield fuse with a bracing or connecting assembly for the non-structural item, or impact by other items such as during installation of other piping, ducting, wiring or the like in the immediate vicinity of the non-structural item being supported by the seismic bracing.

The fuse members disclosed herein may comprise a variety of different materials, and particularly metal materials. Some example materials for use as the fuse member include, for example, mild steel (A36 or similar). However, aluminum or copper may also be used. Other non-ferrous materials may be used in combination with or in place of metal materials for the fuse members. Insulating washers could be incorporated into the fuse to inhibit corrosion if materials other the steel are used. Alternatively, commercially available insulating washers could be provided with the fuses if insulating washers were not incorporated into the fuses. In some embodiments, the housing assembly may provide a sealed enclosure for the fuse member.

The first and second connector members disclosed herein may comprise one or more of a variety of different materials. For example, the first connector member (not shown) may include a metal cable The second connector member (not shown) may include a similar material to that used in the fuse yielding element, or may include a dissimilar material, as described herein.

Typically, the seismic bracing yield fuse as disclosed herein have a relatively small size. For example, the lengths L₁, L₂ are typically in the range of about 3 inches to about 8 inches. The length is determined by the length of material needed to develop desired ductile yielding effects while also being of sufficient strength to resist typical seismic bracing forces. The width W₁, W₂ typically is in the range of about 0.3 inches to about 2.5 inches. The total weight of the seismic bracing yield fuse (i.e., the fuse member and housing assembly without the first and second connector members) typically is in the range of about 4 ounces to about 1-2 pounds, depending upon the fuse capacity.

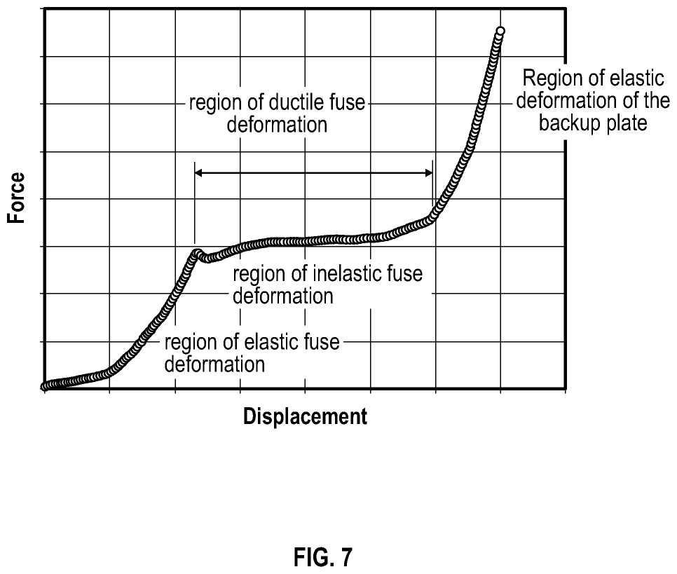

Two tests were conducted on the fuse member and the fuse members and housings. FIG. 7 illustrates the results of the first test conducted on the fuse member 102 and housing plate 202 with loading ceased at the end of ductile fuse deformation and the beginning of fuse housing yielding. The dumbbell shaped fuse member 102 has a necked down portion, which is constant in cross section for most of its length. This geometry showed yielding along the entire length of the necked down portion, resulting in substantially more energy adsorption. The force displacement curve for the dumbbell shaped fuse member 102 is shown in FIG. 7. Note the deformation from 0.23 to 0.6 inches of displacement. The design load limit of the fuse member 102 is about 650 lbs. Above this load level, the backup plate begins to yield.

The overload plate 202 backs up the yielding fuse 102, so that when the fuse deforms excessively, the overall system can still continue to carry load. The overload plate 202 in the second test was approximately eight times stronger than the fuse 102. The first stage is linear yielding of the fuse 102. The second stage is ductile deformation of the fuse 102. This is the most important portion of the curve and illustrates the “ductile yielding” referred to in the building code. This behavior allows the use of Omega=1.0 instead of Omega=2.0 for connections without ductile yielding.

The seismic bracing yield fuses as disclosed herein are specifically designed for use as part of seismic bracing for non-structural items in a building structure, as described above in detail. The size, strength, characteristics, and yield strength of the fuse members for the seismic bracing yield fuse as disclosed herein are on a scale that is much different from fuses used for structural building components such as the beams, brackets and bracing used to define the walls, ceiling, floors, etc. of the building structure itself. Thus, the problem being solved in association with seismic bracing is on a completely different scale. A person of ordinary skill in the art of seismic bracing would have no need to look to fuse members for structural building components because of the vastly different problems being solved, the scale of the features involved, and the like.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A seismic bracing yield fuse for seismically bracing nonstructural equipment from a structural member of a building, comprising:
a fuse member configured to undergo ductile yielding in a length dimension upon application of a tensile or compressive force along the length dimension of the fuse member, the fuse member comprising:
two ends; and
a central bar positioned between the two ends, the central bar comprising a neck down portion comprising a substantially constant cross section.

2. The seismic bracing yield fuse of claim 1, wherein the two ends each have a substantially square or rectangular shape.

3. The seismic bracing yield fuse of claim 2, wherein the two ends each have a first width.

4. The seismic bracing yield fuse of claim 3, wherein the neck down portion has a second width and the second width is less than the first width.

5. The seismic bracing yield fuse of claim 4, wherein the first width is about 0.75 inches to about 2.5 inches.

6. The seismic bracing yield fuse of claim 5, wherein the second width is 30% to 60% of the first width.

7. The seismic bracing yield fuse of claim 1, wherein the neck down portion has a length of about 2 inches to about 6 inches.

8. The seismic bracing yield fuse of claim 1, wherein the central bar further comprises two transition portions positioned on both ends of the neck down portion.

9. The seismic bracing yield fuse of claim 8, wherein the two transition portions each comprise two curved portions positioned on either side of the neck down portion.

10. The seismic bracing yield fuse of claim 9, wherein the two curved portions each have a radius of about 0.5 inches to about 1.25 inches.

11. The seismic bracing yield fuse of claim 1, wherein the fuse member has a length of about 3 inches to about 8 inches.

12. The seismic bracing yield fuse of claim 1, wherein the two ends each define an aperture configured to receive a fastener.

13. The seismic bracing yield fuse of claim 12, wherein the apertures each have a circular or oval shape.

14. The seismic bracing yield fuse of claim 13, wherein the apertures each have a radius of about ⅜ inches to about ⅝ inches.

15. A seismic bracing yield fuse, comprising:
a housing assembly comprising:
a first housing member;
a second housing member at least partially insertable into the second housing member, wherein at least one of the first housing member and the second housing member comprises an overload plate;
a fuse member positionable within the housing assembly, the fuse member configured to undergo ductile yielding in a length dimension upon application of a tensile or compressive force along the length dimension of the fuse member, the fuse member comprising:
two ends; and
a central bar positioned between the two ends, the central bar comprising a neck down portion comprising a substantially constant cross section.

16. The seismic bracing yield fuse of claim 15, wherein the fuse member has a first length, the first housing member has a second length, and the second housing member has a third length, and wherein the first length, the second length, and the third length are substantially equal.

17. The seismic bracing yield fuse of claim 16, wherein the first and second housing members each include snap tabs positioned on exterior surfaces thereof, the snap tabs being configured to snap the first and second housing members to each other to form the housing assembly.

18. A seismic bracing yield fuse, comprising:
an overload plate; and
a fuse member configured to undergo ductile yielding in a length dimension upon application of a tensile or compressive force along the length dimension of the fuse member, the fuse member comprising:
two ends; and
a central bar positioned between the two ends, the central bar comprising a neck down portion comprising a substantially constant cross section.

19. A method of assembling a seismic bracing yield fuse, the method comprising:
providing a housing assembly and a fuse member, the fuse member configured to undergo ductile yielding in a length dimension upon application of a tensile or compressive force along the length dimension of the fuse member, the fuse member comprising two ends and a central bar positioned between the two ends, the central bar comprising a neck down portion comprising a substantially constant cross section;
mounting the fuse member internal to the housing assembly;
providing connection features to secure opposing ends of the fuse member to a connection assembly for application of the tensile force.

20. A method of providing a ductile yield in a connection assembly that supports nonstructural equipment from a structural member of a building, the method comprising:
providing a seismic bracing yield fuse having a housing and a fuse member, the fuse member configured to undergo ductile yielding in a length dimension upon application of a tensile or compressive force along the length dimension of the fuse member, the fuse member comprising two ends and a central bar positioned between the two ends, the central bar comprising a neck down portion comprising a substantially constant cross section;
connecting the seismic bracing yield fuse in series between the structural member and the nonstructural equipment;
applying a tensile force to the fuse member until the fuse member undergoes ductile yielding.
